(19) United States
(12) Patent Application Publication
(10) Pub. No.: US 2009/0114467 A1
(43) Pub. Date: May 7, 2009

(54) Holding device

(76) Inventors: Rainer Hoffman, Ostfildern (DE); Dieter Scheurenbrand, Wolfschlugen (DE); Dirk Schneider, Calw-Alzenberg (DE)

Correspondence Address: KLAUS J. BACH, 4407 TWIN OAKS DRIVE, MURRYSVILLE, PA, 15668, US

(21) Appl. No.: 11/363,503

(22) Filed: Feb. 27, 2006

Related U.S. Application Data
(63) Continuation-in-part of application No. PCT/EP04/09025, filed on Aug. 12, 2004.

(30) Foreign Application Priority Data
Sep. 4, 2003 (DE) 103 41 204.2

(51) Int. Cl. B62D 63/04

(52) U.S. Cl. 180/313; 211/49.1

(57) ABSTRACT

In a holding device and a motor vehicle including such a holding device for gas cylinders, comprising a frame formed by two longitudinal members interconnected at opposite ends by cross-members and supporting a first gas cylinder mounted to the longitudinal members by straps extending around the first gas cylinder, a profiled support rail is disposed on each of the straps and has a first profile fitting the first gas cylinder and at the opposite side a second profile for accommodating a second gas cylinder which is also mounted by straps to the support rail offset sidewardly so that the two cylinders are disposed laterally displaced to facilitate accommodation thereof adjacent an inclined rear seat back wall in the trunk of the motor vehicle.

This is a Continuation-In-Part Application of International application PCT/EP2004/009025 filed Aug. 12, 2004 and claiming the priority of German Application 103 41 204.2 filed Sep. 4, 2003.

### BACKGROUND OF THE INVENTION

The invention relates to a holding device for mounting substantially gas cylinders to a support frame on which they are disposed in spaced relationship, and to a motor vehicle carrying the gas cylinders.

DE 43 10 707 A1 discloses a holder for a gas cylinder which is arranged in a section of an aircraft or vehicle that is at risk of fire and contains an extinguishing medium. The holder comprises a hollow rail made from special steel to which clamp-type straps are fixed with the aid of continuous articulated bars which are mounted at one end in a plastic stopper and at the other end in a plastic insert piece. Plastic stopper and insert piece are fixed on a hollow rail. A bracket is used to fix the valve head of the gas cylinder.

Ever lower exhaust gas emission limits make the use of natural gas as a variant to the pure gasoline- or diesel-operated combustion engine appear expedient in the future. Since natural gas mixes particularly well with air, the emission of harmful substances (including CO₂ and other components, such as, for example, polycyclic aromatic hydrocarbons) is significantly lower than pure gasoline engine operation, even in comparison to fuel injection engines with a controlled three-way catalytic converter. This is because natural gas is free from lead compounds and has very good combustion properties with excellent mixture formation and distribution, which is particularly important for engine operation at low temperatures.

Conversion to natural gas operation is possible in all vehicles with combustion engines. The vehicles may be converted to monovalent or bivalent operation, i.e. either to gasoline/diesel or natural gas operation. Gas cylinders are usually carried on the loading surfaces of trucks or in the trunk compartments of passenger vehicles and they therefore take up a certain loading volume. In addition, gas cylinders which are insufficiently or unsuitably secured lead to an unstable mounting of the same, in particular, for example, during unloading operations, braking operations or rear-end collisions. The cylinders tear loose and put the occupants and the other traffic participants at risk. There is also the risk of the cylinder valves being damaged and the cylinder content being released.

It is the object of the invention to provide a space-saving holding device for substantially cylindrical gas bottles, which is suitable for securely accommodating these gas bottles or cylinders in motor vehicles.

### SUMMARY OF THE INVENTION

In a holding for gas cylinders device and a motor vehicle including such a holding device for gas cylinders, comprising a frame formed by two longitudinal members interconnected at opposite ends by cross-members and supporting a first gas cylinder mounted to the longitudinal members by straps extending around the first gas cylinder, a profiled support rail is disposed on each of the straps and has a first profile fitting the first gas cylinder and at the opposite side a second profile for accommodating a second gas cylinder which is also mounted by straps to the support rail offset sidewardly so that the two cylinders are disposed laterally displaced to facilitate accommodation thereof adjacent an inclined rear seat back wall in the trunk of the motor vehicle.

According to the invention, a profiled piece or profiled rail (6, 6′) is therefore placed on each of the tightening straps (5, 5′) on the side facing away from the longitudinal members (3, 3′), which profiled piece or profiled rail, on the side resting on the tightening strap (5, 5′), has a first profile for the mounting of the first gas cylinder (2) and, on the side facing away from the tightening strap (5, 5′), has a second profile for the mounting of a second gas cylinder (2′), each profiled piece (6, 6′) being connected to a further tightening device (7, 7′) in such a manner that the second gas cylinder (2′) can be braced against the second profile of the profiled piece (6, 6′) by means of the further tightening device (7, 7′).

The holding device comprises at least two profiled pieces which are interconnected by two further longitudinal members 3, the longitudinal members 3 extending essentially parallel to each other.

In an advantageous development of the invention, the profiled pieces have an asymmetrical shape, as viewed in the axial direction of the gas cylinders.

The second profile is constructed for the mounting of a smaller gas cylinder than the first profile.

The second gas cylinder (2′) is arranged in a manner such that it is tilted with respect to the first gas cylinder (2) resting on the longitudinal members (3, 3′).

In a vehicle according to the invention, which is equipped with at least two gas cylinders, the gas cylinders are secured by means of at least one holding device as claimed in one holding device.

In an alternative development, the motor vehicle has an interior space, the interior space being equipped with a floor part and a wall extending with respect to the floor part at an angle of less than 90° thereto.

In a preferred development, the holding device is connected fixedly to the floor part in such a manner that the two gas cylinders are arranged at the smallest possible distance from the wall.

According to a preferred embodiment of the motor vehicle according to the invention, the wall constitutes a rear wall of a rear bench seat of the motor vehicle, which rear wall faces the interior space.

In a further refinement of the invention, the interior space constitutes a trunk compartment 13 of a motor vehicle.

By means of the holding device according to the invention with gas cylinders arranged one above another, in which the upper cylinder has a slight overhang in the direction of the trunk compartment opening, a particularly space-saving accommodation of the gas cylinders is advantageously provided with optimum use of the existing volume or very small losses of volume, with the result that the customary luggage in the form of at least two large cases can still be accommodated in the trunk compartment without any problem.

Furthermore, according to legal specifications, such as, for example, ECE R110, securing devices have to be able to absorb a load of 20 g in the direction of travel and 8 g in the transverse direction. This is provided as a further advantage by the holding device according to the invention in such a manner that, by means of the connection of the upper cylinder to the lower cylinder, all of the forces which occur are conducted directly into the longitudinal members of the body in the rear region of the vehicle, with a further supporting of the upper cylinder advantageously no longer being necessary because of the high connecting forces which the tightening straps apply.

The invention will become more readily apparent from the following description of a preferred embodiment on the basis of the accompanying drawings:

### BRIEF DESCRIPTION OF THE DRAWINGS

FIG. 1 is a perspective illustration of a holding device according to the invention for fastening gas cylinders,

FIG. 2a shows a cross section through the holding device according to the invention,

FIG. 2b shows a cross section through the holding device according to the invention with a trunk compartment lining, and

FIG. 3 shows an installation in the trunk compartment of a vehicle.

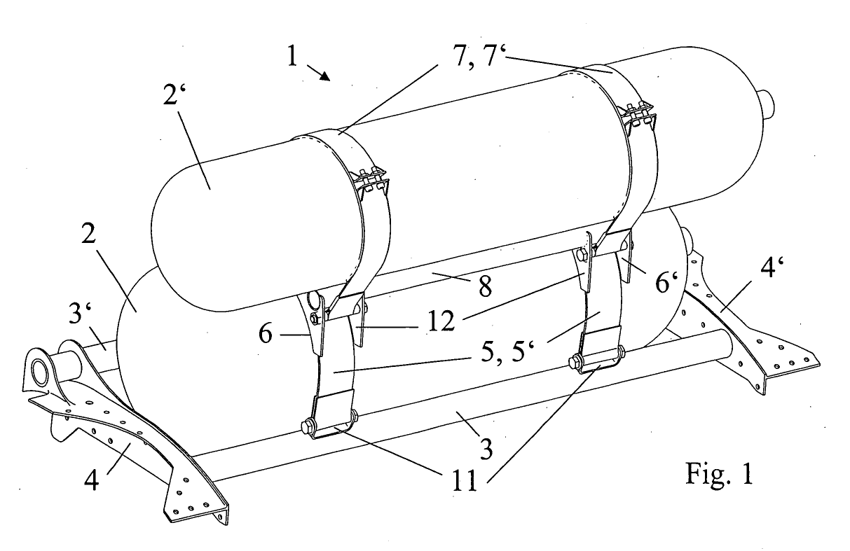

The holding device 1 shown in FIG. 1 for fastening substantially cylindrical gas cylinders 2, 2′ comprises a frame with two longitudinal members 3, 3′ which are connected to each other at their ends by a respective cross member 4, 4′. The distance between the two longitudinal members 3, 3′ is smaller than the diameter of a first gas cylinder 2 to be secured, the two longitudinal members 3, 3′ being connected to each other by means of at least two tightening straps 5, 5′ in such a manner that the first gas cylinder 2 is held between the tightening straps 5, 5′ and the frame by the two longitudinal members 3, 3′. The smaller tightening straps 5, 5′ bear in a form-fitting manner against the outer surfaces of the wall of the cylindrical gas vessel 2. The holding device itself is essentially composed of metal, preferably of steel. The gas cylinders preferably contain natural gas.

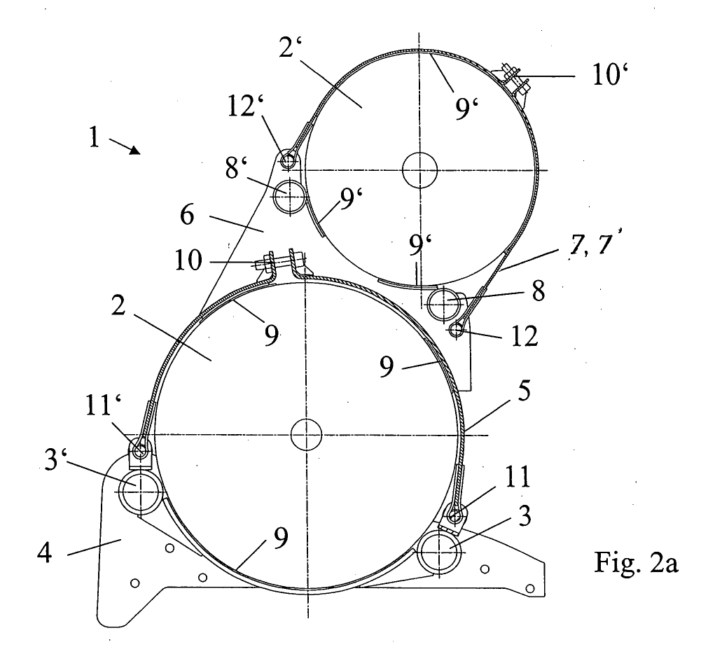

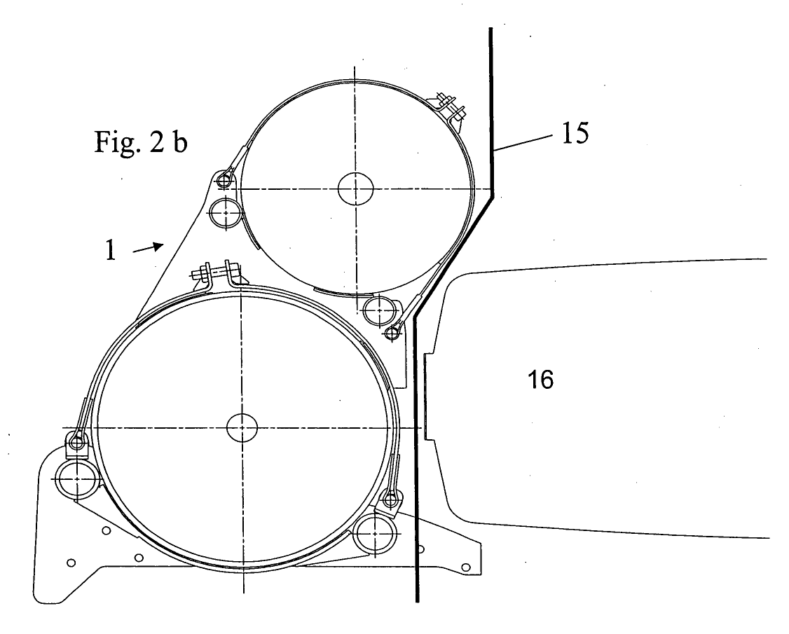

In each case two U-shaped metal members 11, 11′ (shown in FIG. 2a) which are spaced apart from each other are arranged on the longitudinal members 3, 3′ and are fastened with their base to the longitudinal members 3, 3′. The metal members 11,11′ have legs each including a hole through which a support screw with a nut extends, to which in turn a tightening strap 5, 5′ is attached. The width of the tightening strap 5, 5′ and the distance between the legs of the U-shaped metal member 11, 11′ are matched to each other in such a manner that slippage of the tightening strap 5, 5′ is essentially avoided. The tightening straps 5, 5′ are tightened and held by means of tightening members 10, such as, for example, tightening screws with clamping nuts which serve to fasten the gas cylinder 2 on the respective carrier or frame.

According to the invention, a profiled piece or a profiled rail 6, 6′ is placed on each of the tightening straps 5, 5′ on the side facing away from the first gas cylinder 2, which profiled piece or profiled rail is matched in a form-fitting manner to the first gas cylinder 2 on one side and on the opposite side has a profile for the form-fitting mounting of a second gas cylinder 2′, each profiled piece 6, 6′ carrying a tightening strap 7, 7′ by means of which the second gas cylinder 2′ is braced against the respective profiled piece 6, 6′. The tightening strap 7, 7′ is likewise connected in a form-fitting manner to the cylindrical gas vessel. The at least two profiled pieces 6, 6′ are connected to each other by two further longitudinal members 8, 8′ and serve to secure the second gas cylinder, the longitudinal members 8, 8′ extending essentially parallel to each other. The tightening strap 7, 7′ is tightened and held by a mounting screw which extends through two holes 12, 12′ (see FIG. 2a), in the opposite legs of the profiled rails 6, 6′. By means of the profiled rail 6, 6′, slippage of the tightening straps 7, 7′ is also avoided here. Similarly in this case too, tightening fastenings which are known per se, such as, for example, the tightening screws with clamping nuts 10′ also shown in FIG. 2a, are used for fastening the gas cylinder on the respective profiled piece 6.

The frame of the holding device 1 is connected non-releasably via the cross members 4, 4′ to longitudinal body members (not shown) in the rear region of the vehicle body. This can take place by riveting, welding and/or screwing the cross members 4, 4′ to the body.

The tightening straps, which serve to fixedly, but releasably loop around the cylindrical body, and the fastening of the frame to the vehicle body in an advantageous manner prevent movement of the gas cylinders due to dynamic loading. Because the load forces may occur abruptly, corresponding exacting requirements are to be made of the fastening system. Dynamic loads can be generated, for example, by acceleration, deceleration, cornering, an inclined position or a crash of the vehicle. The tightening force or the tightening torque between tightening straps and gas cylinders therefore has to be selected to be correspondingly high. Furthermore, as shown in FIG. 2a, the cylindrical body 2, 2′ is held immovably, in particular in a manner fixed against rolling and slipping, by means of a slip-proof covering 9, 9′ which is situated entirely or partially, but at least in the clamping region of the tightening strap or in the bearing region of the cross member 4, 4′ or of the profiled piece 6, 6′, between the outer circumference of the gas cylinder and the lower side of the tightening strap or the bearing surface of the longitudinal member or the profiled rail in a form-fitting manner. The slip-proof covering is composed of a microcellular rubber, open-cell foam, rubber, silicone (rubber) or an equivalent material with a high coefficient of friction connected to the tightening strap. All of the measures taken together reliably prevent the gas cylinders from being released, tearing loose or migrating both in the axial direction of the gas cylinders and also as seen in the direction of travel of the motor vehicle.

As FIG. 2a shows, both, the cross member 4 associated with the frame and the cross-member 4′ (not shown in FIG. 2a) and the profiled piece or rail 6 and the rail 6′ (not depicted in FIG. 2a) have an asymmetrical shape in the axial direction of the gas cylinders 2, 2′. This means, that the upper gas cylinder 2′, which is arranged in the holding device 1, is attached in a manner such that it can be in a tilted position with respect to the lower cylinder 2 resting on the frame. Furthermore, by means of the connection of the upper gas cylinder 2′ to the lower cylinder 2, the high forces of up to 20 g (20 times gravity) occurring in the direction of travel and the forces of up to 8 g occurring in the transverse direction are advantageously transmitted directly to the longitudinal frame members of the vehicle body. The longitudinal members 3, 3′ and 8, 8′ of the holding device 1, which longitudinal members extend parallel to each other, also serve to stabilize the gas cylinders 2, 2′.

FIG. 2b shows a variant of the holding device according to the invention of FIG. 2a, in which, for the components which are identical functionally or act in an identical manner, reference is made to the labeling of the drawing and description of FIG. 2a. The holding device 1 according to the invention is covered for appearance reasons with a trunk compartment lining 15. By means of the arrangement according to the invention of the holding device, very large items of luggage 16 can be loaded in the lower region without the upper, smaller dimensioned gas cylinder having an interfering effect. As shown in FIG. 2b the cylinders 2, 2′ are slightly oval in cross-section to reduce the height of the arrangement.

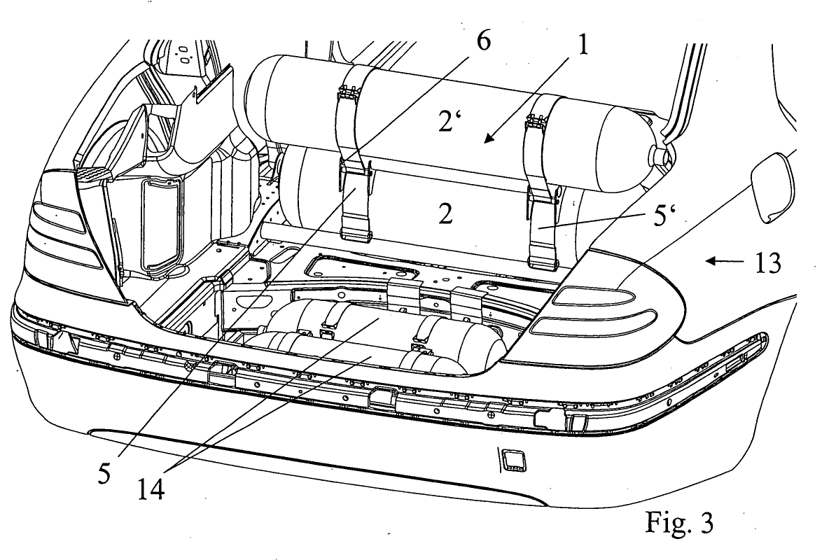

FIG. 3 shows the installation of a holding device 1 according to the invention in the rear trunk compartment 13 of a motor vehicle. The slightly inclined arrangement of the gas cylinders 2, 2′ with respect to each other can be seen, with the upper cylinder carrier 6 being held on the lower cylinder 2 by the lower tightening straps 5, 5′. A twisting of the tightening straps is ruled out by the very high tightening forces of the tightening straps. This type of fastening makes it possible to accommodate the gas cylinders 2, 2′ in a space-saving and secure manner. In order to ensure a sufficient vehicle operating range, further gas cylinders 14 arranged in a crash-secure carrier (not illustrated) may be accommodated in the lower region of the trunk compartment floor. The interior space depicted in FIG. 3, here the trunk compartment 13 of a motor vehicle, is equipped with a floor part (not shown) and a wall (not shown) extending with respect to the floor part at an angle of less than 90°. The holding device is connected fixedly to the floor part in such a manner that the two gas cylinders 2, 2′ are arranged at the smallest possible distance from the wall, the wall constituting a rear wall of a rear seat of the motor vehicle, which rear wall faces the interior vehicle space. In order to optimally use the volume arising because of the inclination or of the inclined profile of the wall, the diameter of the second gas cylinder 2′ is selected to be smaller than the diameter of the first gas cylinder 2 and, as already mentioned, the upper gas cylinder 2′ is fitted in a manner such that it is tilted with respect to the lower cylinder 2 resting on the frame. This has the great advantage that the holding device 1 which is accommodated in a particularly space-saving arrangement in the rear part of the trunk compartment adjacent the seat back rests can be fitted with only small losses of trunk volume.

1. A holding device (1) for supporting gas cylinders (2, 2′) in a motor vehicle, comprising a frame formed by two longitudinal members (3, 3′) which are interconnected at opposite ends by respective cross members (4, 4′) so as to be fixed at a certain distance from each other, a first gas cylinder (2) disposed on the longitudinal members (3, 3′), a holding straps (5, 5′) connected to the two longitudinal members (3, 3′) and extending around the first gas cylinder (2) for firmly engaging the first gas cylinder (2) with the longitudinal members (3, 3′), a support rail (6, 6′) engaged by each of the holding straps (5, 5′) on the side facing away from the longitudinal members (3, 3′) so that the support rails (6, 6′) are held in position on the first gas cylinder (2) and having on the side resting on the first gas cylinder (2) a first profile fitting the first gas cylinder (2) and, on the side facing away from the holding straps (5, 5′) a second profile for accommodating a second gas cylinder (2′), and a tightening device (7, 7′) mounted to the support rail (6, 6′) and extending around the second gas cylinder (2′) in such a manner that the second gas cylinder (2′) is firmly engaged with the second profile of the support rail (6, 6′) by the tightening device (7, 7′) so that the second gas cylinder (2′) is connected to the first gas cylinder (2).

2. The holding device as claimed in claim 1, wherein the at least two profiled pieces (6, 6′) are connected to each other by two further longitudinal members (8, 8′), extending essentially parallel to each other.

3. The holding device as claimed in claim 1, wherein the profiled support rails (6, 6′) have an asymmetrical shape, as viewed in the axial direction of the gas cylinders (2, 2′).

4. The holding device as claimed in claim 1, wherein the second profile is shaped for accommodating a smaller gas cylinder than the first profile.

5. The holding device as claimed in claim 1, wherein the second gas cylinder (2′) is arranged in a manner such that it is tilted with respect to the first gas cylinder (2) resting on the longitudinal members (3, 3′).

6. A motor vehicle equipped with at least two gas cylinders (2, 2′), the gas cylinders (2, 2′) being secured by means of a holding device (1) for supporting gas cylinders (2, 2′) in a motor vehicle, comprising a frame formed by two longitudinal members (3, 3′) which are interconnected at opposite ends by respective cross members (4, 4′) so as to be fixed at a certain distance from each other, a first gas cylinder (2) disposed on the longitudinal members (3, 3′), a holding straps (5, 5′) connected to the two longitudinal members (3, 3′) and extending around the first gas cylinder (2) for firmly engaging the first gas cylinder (2) with the longitudinal members (3, 3′), a support rail (6, 6′) engaged by each of the holding straps (5, 5′) on the side of the first gas cylinder (2) facing away from the longitudinal members (3, 3,) and having on the side resting on the first gas cylinder (2) a first profile fitting the first gas cylinder (2) and, on the side facing away from the first gas cylinder (2) a second profile for accommodating a second gas cylinder (2′), and a tightening device (7, 7′) mounted to the support rail (6, 6′) and extending around the second gas cylinder (2′) in such a manner that the second gas cylinder (2′) is firmly engaged with the second profile of the support rail (6, 6′) by the tightening device (7, 7′) and the second gas cylinder (2′) is connected to the first gas cylinder (2).

7. The motor vehicle as claimed in claim 6, wherein the motor vehicle has an interior space, the interior space being equipped with a floor part and a wall (15) extending with respect to the floor part generally at an angle of less than 90° thereto, and the holding device (1) being connected fixedly to the floor part in such a manner that the two gas cylinders (2, 2′) are arranged closely adjacent the wall (15).

8. The motor vehicle as claimed in claim 7, wherein the wall constitutes a rear wall of a rear seat of the motor vehicle, which rear wall faces an interior space.

9. The motor vehicle as claimed in claim 8, wherein the interior space constitutes a trunk (13) of a motor vehicle.
